(19) United States
(12) Patent Application Publication
(10) Pub. No.: US 2026/0183694 A1
(43) Pub. Date: Jul. 2, 2026

(54) CARBON DIOXIDE RECOVERY APPARATUS, CARBON DIOXIDE RECOVERY METHOD, AND CARBON DIOXIDE RECOVERY SYSTEM

(71) Applicant: Mitsubishi Electric Corporation, Tokyo (JP)

(72) Inventors: Makoto TANISHIMA, Tokyo (JP); Takumi INOUE, Tokyo (JP); Yoji ONAKA, Tokyo (JP); Toshio SHINOKI, Tokyo (JP); Tomoya FUKUI, Tokyo (JP)

(73) Assignee: Mitsubishi Electric Corporation, Tokyo (JP)

(21) Appl. No.: 18/857,828

(22) PCT Filed: May 31, 2022
(86) PCT No.: PCT/JP2022/022030

§ 371 Date: Oct. 18, 2024

(51) Int. Cl. B01D 53/04; B66B 11/00

(52) U.S. Cl. CPC B01D 53/04; B66B 11/005; B01D 2257/504; B01D 2258/06

(57) ABSTRACT

A carbon dioxide recovery apparatus according to the present disclosure includes a container having air permeability and disposed outside an elevator cab or outside a counterweight in a hoistway of the elevator cab, and an adsorbent adsorbing carbon dioxide and contained in the container.

### TECHNICAL FIELD

The present disclosure relates to a carbon dioxide recovery apparatus, a carbon dioxide recovery method, and a carbon dioxide recovery system.

### BACKGROUND ART

Patent Document 1 discloses a technology for removing carbon dioxide in the air using an adsorbent capable of adsorbing carbon dioxide.

### CITATION LIST

### Patent Document

Patent Document 1: Japanese Unexamined Patent Application, First Publication No. 2020-131166

### SUMMARY OF INVENTION

### Problem to be Solved by the Invention

When carbon dioxide is adsorbed onto an adsorbent, a carbon dioxide concentration in the air on a surface of the adsorbent gradually decreases. If the carbon dioxide concentration decreases, recovery efficiency of carbon dioxide by the adsorbent decreases. Therefore, in order to maintain the recovery efficiency of carbon dioxide, it is preferable to continuously expose the adsorbent to air in which the carbon dioxide concentration has not decreased. However, for example, if equipment solely for exposing the adsorbent to air is provided, actual recovery efficiency of carbon dioxide in the entire system may decrease due to power consumption of the equipment.

The present disclosure has been made in view of the above circumstances, and an objective of the present disclosure is to provide a carbon dioxide recovery apparatus, a carbon dioxide recovery method, and a carbon dioxide recovery system that are capable of maintaining recovery efficiency of carbon dioxide in an entire system.

### Solution to Problem

One aspect of a carbon dioxide recovery apparatus according to the present disclosure includes a container having air permeability and disposed outside an elevator cab or outside a counterweight in a hoistway of the elevator cab, and an adsorbent adsorbing carbon dioxide and contained in the container.

One aspect of a carbon dioxide recovery method according to the present disclosure includes a filling step of filling an adsorbent adsorbing carbon dioxide into a container having air permeability and disposed outside an elevator cab or outside a counterweight in a hoistway of the elevator cab, an adsorption step of causing carbon dioxide to be adsorbed onto the adsorbent by raising and lowering the elevator cab to bring the adsorbent into contact with air containing carbon dioxide, and a recovery step of recovering the adsorbent which has adsorbed carbon dioxide from the container.

One aspect of a carbon dioxide recovery system according to the present disclosure includes the carbon dioxide recovery apparatus, the elevator cab, the counterweight, and a control panel that controls raising and lowering of the elevator cab.

### Effects of the Invention

According to the present disclosure, it is possible to provide a carbon dioxide recovery apparatus, a carbon dioxide recovery method, and a carbon dioxide recovery system that are capable of maintaining recovery efficiency of carbon dioxide in the entire system.

### BRIEF DESCRIPTION OF DRAWINGS

FIG. 1 is a schematic diagram of a carbon dioxide recovery system according to embodiment 1.

FIG. 2 is a schematic diagram of a carbon dioxide recovery system according to embodiment 2.

FIG. 3 is a cross-sectional view along line A-A indicated by the arrow illustrated in FIG. 2.

FIG. 4 is a schematic diagram of a carbon dioxide recovery system according to embodiment 3.

FIG. 5 is a graph showing a relationship between a loading ratio and power consumption in an elevator apparatus.

FIG. 6 is a schematic diagram of a carbon dioxide recovery system according to embodiment 4.

FIG. 7 is a schematic diagram of a carbon dioxide recovery system according to embodiment 5.

FIG. 8 is a schematic diagram showing a part of a configuration of a carbon dioxide recovery system according to embodiment 6.

### DESCRIPTION OF EMBODIMENTS

Hereinafter, embodiments of the present disclosure will be described with reference to the drawings. Further, the scope of the present disclosure is not limited to the following embodiments, and can be freely modified within the scope of the technical ideas of the present disclosure.

### Embodiment 1

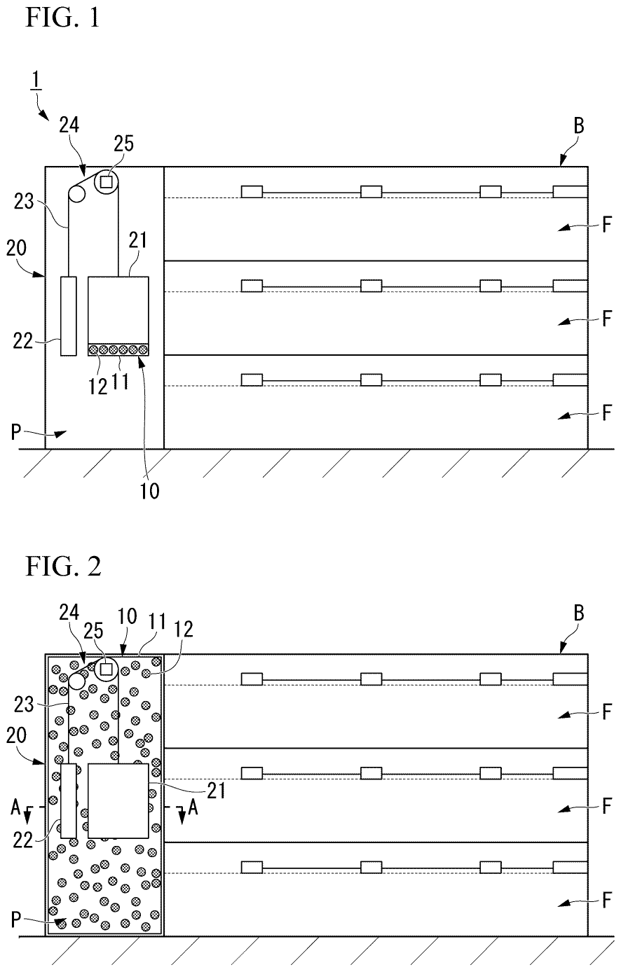

FIG. 1 is a schematic diagram illustrating a carbon dioxide recovery apparatus and a carbon dioxide recovery system according to embodiment 1.

As illustrated in FIG. 1, the carbon dioxide recovery system 1 includes a carbon dioxide recovery apparatus 10 and an elevator apparatus 20. The carbon dioxide recovery system 1 is provided in a building B that includes the elevator apparatus 20.

The elevator apparatus 20 includes an elevator cab 21, a counterweight 22, a rope 23, a hoisting machine 24, a control panel 25, and the like. The elevator cab 21 and the counterweight 22 are disposed in a hoistway P provided in the building B. Also, the elevator cab 21 and the counterweight 22 can move up and down in the hoistway P. The elevator apparatus 20 may be of a type for loading and unloading passengers, and may be of a type of freight only.

The elevator cab 21 and the counterweight 22 are each fixed to either end of the rope 23. The hoisting machine 24 feeds the rope 23 to raise and lower the elevator cab 21. The control panel 25 is electrically connected to the hoisting machine 24. The control panel 25 is disposed in the vicinity of the hoisting machine 24 in the figure, but the control panel 25 may be disposed apart from the hoisting machine 24. The control panel 25 controls a length, a speed, a direction, or the like of the rope 23 being fed by the hoisting machine 24. On the basis of the control of the control panel 25, the elevator cab 21 moves between each floor F of the building B and stops at each floor F. In the figure, the number of the floors F of the building B is three, but the number of the floors F may be two, or may be four or more.

The carbon dioxide recovery apparatus 10 includes a container 11 and an adsorbent 12. The carbon dioxide recovery apparatus 10 is disposed outside the elevator cab 21 or outside the counterweight 22 in the hoistway P. In FIG. 1, the carbon dioxide recovery apparatus 10 is fixed to a lower side of the elevator cab 21. However, the carbon dioxide recovery apparatus 10 may be fixed to an upper side or a lower side of the counterweight 22.

The container 11 has air permeability. Therefore, when the elevator cab 21 and the counterweight 22 move up and down, air in the hoistway P enters the inside of the container 11. Also, the air in the container 11 is discharged into the hoistway P. That is, the air in the container 11 can be replaced with the air in the hoistway P by the up and down movement of the elevator cab 21 and the counterweight 22.

The container 11 need only be capable of containing the adsorbent 12 and having air permeability. For example, if the adsorbent 12 is granular, a plurality of holes smaller than a grain size of the adsorbent 12 may be formed in the container 11. The container 11 may entirely or partially have a mesh shape. A material of the container 11 can be changed as appropriate, and may be a metal or a resin. A structure other than that described above may be employed for the container 11.

The adsorbent 12 contains a material capable of adsorbing carbon dioxide. Examples of materials capable of adsorbing carbon dioxide include amines, zeolites, silica gel, diatomaceous earth, alumina, activated carbon, and the like. A plurality of the above materials may be selected and employed, or a material other than those described above may be employed. The adsorbent 12 may be in a granular form (for example, a bead form (spherical form) or a pellet form (columnar shape)). Alternatively, the adsorbent 12 in a powdered form may also be employed. In this case, the powdered adsorbent 12 may be supported on a surface of a base material. The base material may, for example, be in the form of a honeycomb.

The carbon dioxide recovery method according to the present embodiment includes a filling step, an adsorption step, and a recovery step.

In the filling step, the adsorbent 12 is filled into the container 11.

In the adsorption step, carbon dioxide is adsorbed onto the adsorbent 12 by raising and lowering the elevator cab 21 to bring air containing carbon dioxide into contact with the adsorbent 12.

In the recovery step, the adsorbent 12 that has adsorbed carbon dioxide is recovered from the container 11.

Further, the recovery step may be performed, for example, during maintenance and inspection of the elevator apparatus 20. At this time, the adsorbent 12 that has adsorbed carbon dioxide may be taken out of the container 11, and new adsorbent 12 may be filled into the container 11. Alternatively, the container 11 may be replaced in its entirety. The carbon dioxide may be extracted from the recovered adsorbent 12 and used to produce methane or the like.

As described above, the carbon dioxide recovery apparatus 10 according to the present embodiment includes the container 11 having air permeability and disposed outside the elevator cab 21 or outside the counterweight 22 in the hoistway P of the elevator cab 21, and the adsorbent 12 adsorbing carbon dioxide and contained in the container 11.

Also, the carbon dioxide recovery method according to the present embodiment includes the filling step of filling the adsorbent 12 adsorbing carbon dioxide into the container 11 having air permeability and disposed outside the elevator cab 21 or outside the counterweight 22 in the hoistway P of the elevator cab 21, the adsorption step of causing carbon dioxide to be adsorbed onto the adsorbent 12 by raising and lowering the elevator cab 21 to bring the adsorbent 12 into contact with air containing carbon dioxide, and the recovery step of recovering the adsorbent 12 that has adsorbed carbon dioxide from the container 11.

According to such a carbon dioxide recovery apparatus 10 or carbon dioxide recovery method, the air in the container 11 can be efficiently replaced with the air in the hoistway P by using an airflow generated in the hoistway P as the elevator apparatus 20 operates. Thereby, air whose carbon dioxide concentration has been lowered due to the contact with the adsorbent 12 can be discharged from the container 11, and air whose carbon dioxide concentration has not been lowered can be taken into the container 11. Therefore, it is possible to maintain recovery efficiency of carbon dioxide. Also, energy saving and cost reduction can be achieved compared to a case in which, for example, a dedicated fan or the like for generating an airflow is used, and the recovery efficiency of carbon dioxide in the entire system can be maintained.

Also, the container 11 may be fixed to an upper side or a lower side of the elevator cab 21. In this case, air is likely to hit the container 11 as the elevator cab 21 moves up and down. Therefore, it becomes possible to more efficiently replace the air in the container 11 with the air in the hoistway P, thereby improving the recovery efficiency of carbon dioxide. Also, an installation area of the carbon dioxide recovery apparatus 10 can be made larger compared to a case in which the container 11 is fixed to the counterweight 22. That is, since an amount of the adsorbent 12 filled into the container 11 can be increased, it is possible to improve the recovery efficiency of carbon dioxide. The container 11 may be fixed to both the upper and lower sides of the elevator cab 21. If the container 11 is fixed not only to the upper and lower sides of the elevator cab 21 but also to the outside of the counterweight 22, the recovery efficiency can be further improved.

Here, for example, if an operation rate of the elevator apparatus 20 is low, it is conceivable that there will be fewer opportunities for wind to hit the carbon dioxide recovery apparatus 10, and the recovery efficiency of carbon dioxide will decrease. Therefore, if a stop time of the elevator cab 21 exceeds a threshold value, the elevator cab 21 may be raised or lowered without any operation by a user or the like. This control may be performed by the control panel 25 or by other control devices. The threshold value can be set appropriately, but may be, for example, 10 minutes.

In this way, when the elevator cab 21 is raised and lowered when the stop time of the elevator cab 21 exceeds the threshold value, the recovery efficiency of carbon dioxide by the carbon dioxide recovery apparatus 10 can be maintained even in a state in which the operation rate of the elevator apparatus 20 is low.

### Embodiment 2

Next, a carbon dioxide recovery system according to embodiment 2 will be described. The carbon dioxide recovery system according to the present embodiment has a basic configuration similar to that of embodiment 1, and therefore description will be made focusing on different points.

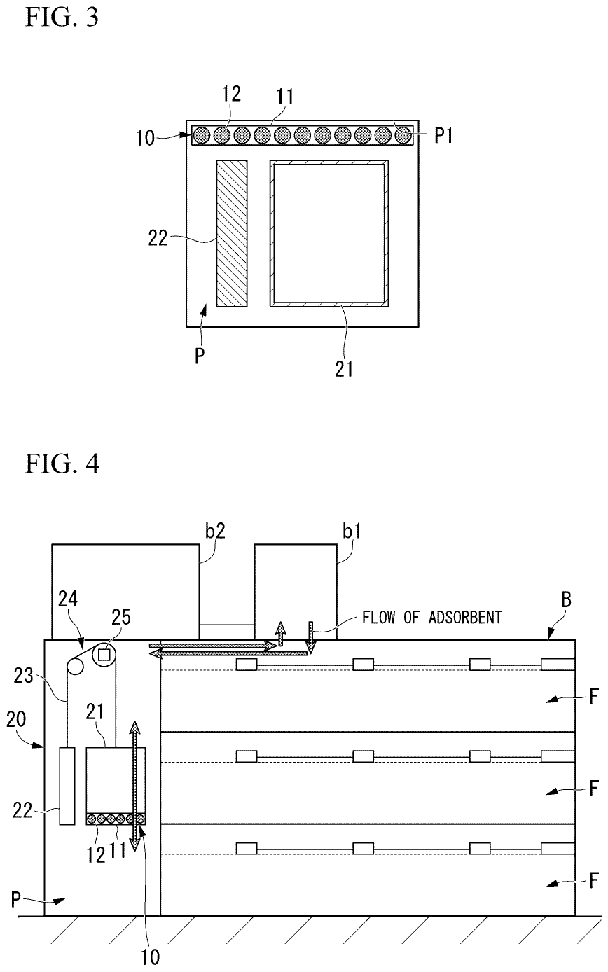

In embodiment 1, the carbon dioxide recovery apparatus 10 is fixed to the elevator cab 21 or the counterweight 22, and moves up and down as the elevator apparatus 20 operates. In contrast, in the present embodiment, a carbon dioxide recovery apparatus 10 is fixed to a wall surface of a hoistway P as illustrated in FIGS. 2 and 3. That is, in the present embodiment, the carbon dioxide recovery apparatus 10 remains stationary inside the hoistway P even when an elevator apparatus 20 operates.

In the example of FIGS. 2 and 3, a container 11 is disposed along a wall surface P1 in the hoistway P. Then, the container 11 is filled with an adsorbent 12. The container 11 may be disposed across a plurality of floors F. Alternatively, a plurality of containers 11 may be disposed on each floor F.

If the container 11 is fixed inside the hoistway P as in the present embodiment, an airflow generated in the hoistway P when the elevator apparatus 20 operates hits the stationary container 11. By this airflow, air in the container 11 can be replaced with air in the hoistway P. Then, a volume of the container 11 and an amount of the adsorbent 12 filled in the container 11 can be increased. Therefore, recovery efficiency of carbon dioxide can be further improved.

### Embodiment 3

Next, a carbon dioxide recovery system according to embodiment 3 will be described. The carbon dioxide recovery system according to the present embodiment has a basic configuration similar to that of embodiment 1, and therefore description will be made focusing on different points.

As illustrated in FIG. 4, in the present embodiment, a separation device b1 and a methanation system b2 are provided in a building B.

The separation device b1 has a function of separating carbon dioxide from an adsorbent 12. The separation device b1 may include a heater and separate carbon dioxide by heating the adsorbent 12 (for example, at 60 to 120° C.). A heating temperature may be appropriately changed according to a specific material of the adsorbent 12. Alternatively, the separation device b1 may include a vacuum pump and separate carbon dioxide by placing the adsorbent 12 under a condition of a reduced pressure.

The methanation system b2 has a function of producing methane using carbon dioxide, water, electricity, and the like. The methanation system b2 may produce methane using electricity generated using renewable energy (for example, solar light, or the like). Solar cells or the like for operating the methanation system b2 may be provided in the building B.

A carbon dioxide recovery system 1 according to the present embodiment circulates the adsorbent 12 as follows.

First, carbon dioxide is adsorbed onto the adsorbent 12 in the hoistway P.

Next, the adsorbent 12 is fed from a container 11 to the separation device b1.

Next, carbon dioxide is separated from the adsorbent 12 by the separation device b1.

Next, the separated carbon dioxide is fed to the methanation system b2, and methane is produced in the methanation system b2.

Next, the adsorbent 12 from which the carbon dioxide has been separated is fed to the container 11 and is filled into the container 11.

Further, a storage tank for storing the adsorbent 12 after carbon dioxide has been separated may be provided. In this case, the above-described circulation of the adsorbent 12 can be performed without delay.

Here, when the adsorbent 12 is filled into the container 11, an amount of the adsorbent 12 filled into the container 11 may be changed according to a loading ratio of an elevator cab 21. For example, the amount of the adsorbent 12 filled into the container 11 may be controlled by a control panel 25. The loading ratio of the elevator cab 21 can be determined by the following expression (1). In expression (1), R is a loading ratio (%), x1 is a weight of the elevator cab 21, x2 is a load weight in the elevator cab 21, x3 is a weight of a carbon dioxide recovery apparatus 10 fixed to the elevator cab 21, and n is a permissible weight.

R=(x1+x2+x3)/n×100 (1)

Further, a value of (x1+x2+x3) can be acquired by, for example, using a sensor that measures a load applied to a rope 23. The control panel 25 may calculate the loading ratio R on the basis of the value of x1+x2+x3 measured by the sensor.

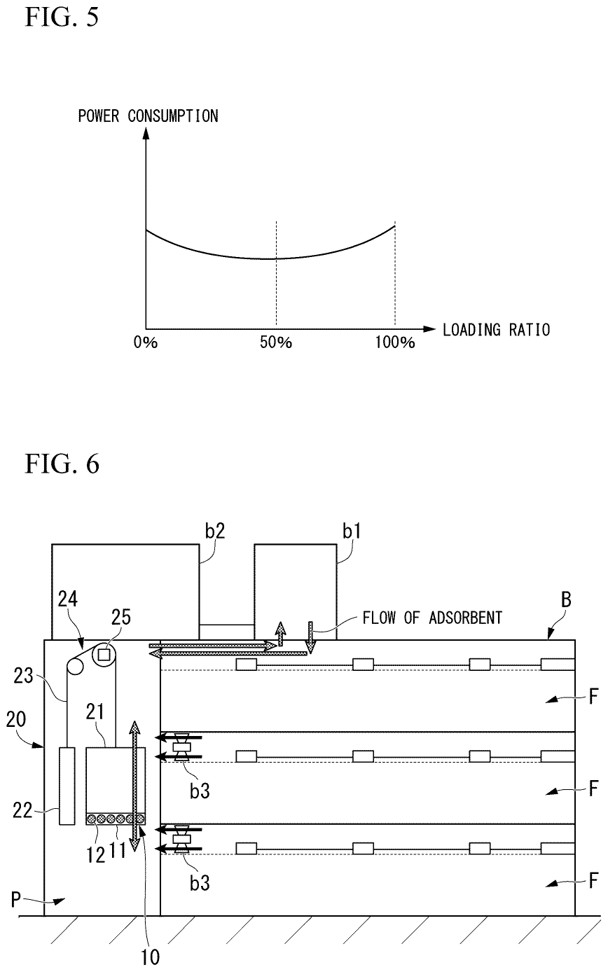

FIG. 5 is a graph showing a relationship between the loading ratio R and power consumption of an elevator apparatus 20. As shown in FIG. 5, when the loading ratio R is 50%, the power consumption of the elevator apparatus 20 is minimum. Therefore, if the loading ratio R is 50% or less, the adsorbent 12 may be filled into the container 11 (that is, a value of x3 may be increased) to bring the loading ratio R closer to 50%. In this case, it is possible to reduce the power consumption of the elevator apparatus 20 by filling the adsorbent 12 into the container 11. It is more preferable that the amount of adsorbent 12 filled into the container 11 be controlled so that the loading ratio R becomes 50%.

### Embodiment 4

Next, a carbon dioxide recovery system according to embodiment 4 will be described. The carbon dioxide recovery system according to the present embodiment has a basic configuration similar to that of embodiment 3, and therefore description will be made focusing on different points.

As illustrated in FIG. 6, in the present embodiment, a blower b3 is provided in a building B. The blower b3 is provided on each floor F and feeds air in the floor F into the hoistway P. A carbon dioxide concentration of the air in the floor F often increases due to human breathing. Therefore, when the air in the floor F is fed into the hoistway P, a carbon dioxide concentration in the hoistway P can be increased. A step of increasing the carbon dioxide concentration in the hoistway P is referred to as a “concentration increasing step” in the present specification.

That is, a carbon dioxide recovery method according to the present embodiment further includes the concentration increasing step in addition to the filling step, the adsorption step, and the recovery step. In the concentration increasing step, the carbon dioxide concentration in the hoistway P is increased by feeding air from the floor F to the hoistway P. Thereby, recovery efficiency of carbon dioxide by a carbon dioxide recovery apparatus 10 can be further improved.

Further, the carbon dioxide concentration in the hoistway P may be increased using means other than the blower b3.

### Embodiment 5

Next, a carbon dioxide recovery system according to embodiment 5 will be described. The carbon dioxide recovery system according to the present embodiment has a basic configuration similar to that of embodiment 3, and therefore description will be made focusing on different points.

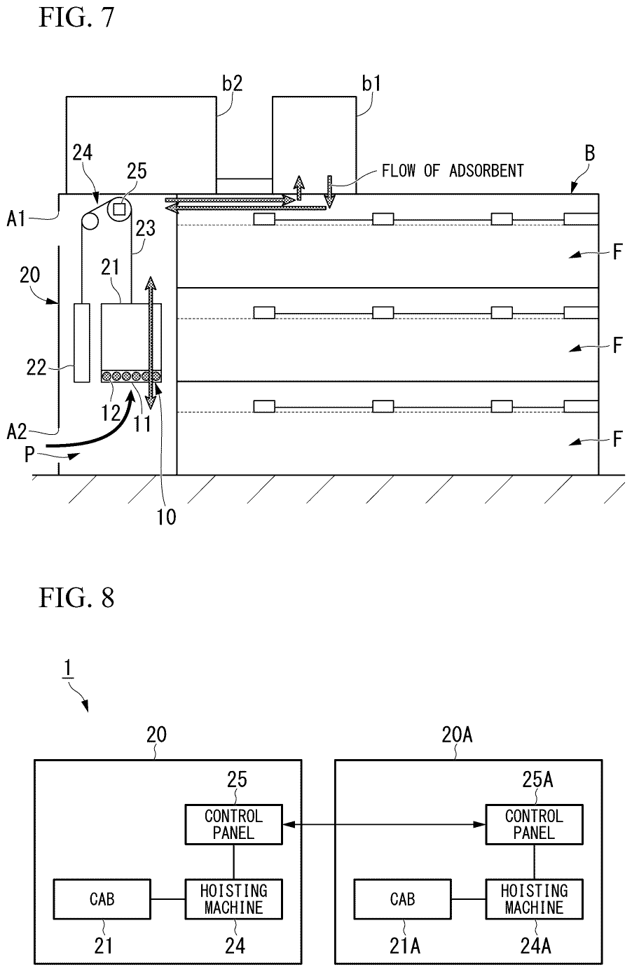

As illustrated in FIG. 7, in the present embodiment, ventilation openings A1 and A2 are provided in a hoistway P. In FIG. 7, the number of the ventilation openings A1 and A2 is two, but this number can be changed as appropriate, and may be one, or three or more. The first ventilation opening A1 is disposed at an upper end portion of the hoistway P, and the second ventilation opening A2 is disposed at a lower end portion of the hoistway P.

As adsorption of carbon dioxide by a carbon dioxide recovery apparatus 10 progresses, a carbon dioxide concentration in air in the hoistway P gradually decreases. When the carbon dioxide concentration decreases, recovery efficiency of carbon dioxide by the carbon dioxide recovery apparatus 10 decreases. Therefore, in the present embodiment, outside air is taken into the hoistway P through the ventilation openings A1 and A2. Thereby, the carbon dioxide concentration in the hoistway P can be restored to the same level as that in the outside air, and thereby a decrease in the recovery efficiency of carbon dioxide can be suppressed.

Further, the ventilation openings A1 and A2 may be simple openings. Also, ventilation fans may be disposed at the ventilation openings A1 and A2 to actively cause outside air to flow into the hoistway P. Outside air may be taken into the hoistway P through one of the ventilation openings A1, A2, and the air in the hoistway P may be discharged through the other of the ventilation openings A1, A2.

### Embodiment 6

Next, a carbon dioxide recovery system according to embodiment 6 will be described. The carbon dioxide recovery system according to the present embodiment has a basic configuration similar to that of embodiment 1, and therefore description will be made focusing on different points.

In the present embodiment, a case in which a building B includes a plurality of elevator apparatuses 20 will be described.

For example, in an elevator hall of a building or an apartment complex, a plurality of elevator apparatuses are often provided parallel to each other to reduce a waiting time for an elevator. If there is one or more elevator apparatuses 20 on standby, even if the other elevator apparatuses 20 are operated for recovering carbon dioxide, an increase in waiting time for passengers can be avoided. That is, when the elevator apparatus 20 is operated in a state in which there are no passengers or the like on board, the waiting time can be effectively utilized to recover carbon dioxide.

Therefore, in the present embodiment, a configuration as illustrated in FIG. 8 is employed. That is, a carbon dioxide recovery system 1 includes a plurality of elevator apparatuses 20 and 20A. A structure of the elevator apparatus 20A may be the same as that of the elevator apparatus 20. The elevator apparatus 20A includes an elevator cab 21A, a hoisting machine 24A, and a control panel 25A. The control panel 25A controls the hoisting machine 24A to raise and lower the elevator cab 21A. Also, communication is conducted between a control panel 25 and the control panel 25A, and mutual operation status is shared. A carbon dioxide recovery apparatus 10 may be fixed to the elevator cab 21A similarly to the first elevator cab 21 in embodiment 1. Alternatively, the elevator cabs 21 and 21A may be disposed in a common hoistway P, and the carbon dioxide recovery apparatus 10 may be fixed inside the hoistway P as in embodiment 2.

The control panels 25 and 25A communicate with each other, and if one of the elevator cabs 21 and 21A is stopped, the other is raised or lowered. For example, if the elevator cab 21 is stopped, the elevator cab 21A is raised and lowered. Since wind hits the carbon dioxide recovery apparatus 10 as the elevator cab 21A is raised and lowered, recovery of carbon dioxide by the adsorbent 12 can be promoted.

As described above, the carbon dioxide recovery system 1 of the present embodiment includes the plurality of elevator cabs (the first elevator cab 21 and the second elevator cab 21A) and the plurality of control panels (the first control panel 25 and the second control panel 25A). The control panel 25A communicates with the control panel 25, and raises and lowers the elevator cab 21A if the elevator cab 21 is stopped. According to this configuration, recovery efficiency of carbon dioxide can be improved while avoiding an increase in waiting time for passengers. The same control can also be applied to a case in which three or more elevator apparatuses are provided parallel to each other.

Further, the technical scope of the present disclosure is not limited to the above-described embodiments, and various modifications can be made in a range not departing from the spirit of the present disclosure.

For example, instead of the methanation system b2 or in addition to the methanation system b2 described in embodiment 3, a cylinder capable of storing carbon dioxide may be provided. In this case, the carbon dioxide separated from the adsorbent 12 by the separation device b1 can be stored in the cylinder. The cylinder in which the carbon dioxide is stored may be transported to another location (such as, for example, a factory), and the carbon dioxide may be used.

In addition, the embodiments and modified examples described above may be combined as appropriate.

For example, in the carbon dioxide recovery system 1 in which the container 11 is fixed inside the hoistway P as in embodiment 2, the adsorbent 12 may be caused to circulate as described in embodiment 3.

Further, the control panel 25 described above has a computer system therein. Then, a program for realizing functions of each configuration of the carbon dioxide recovery system 1 described above may be recorded on a computer-readable recording medium, and the processing in the control panel 25 described above may be performed by causing the computer system to read and execute the program recorded on the recording medium. Also, hardware other than the control panel 25 may perform the processing described above.

Here, the “causing the computer system to read and execute the program recorded on the recording medium” includes installing the program on the computer system. The “computer system” described herein includes an OS and hardware such as peripheral devices.

Also, the “computer system” may include a plurality of computer devices connected via a network including the Internet or a communication line such as a WAN, LAN, or dedicated line. Also, the “computer-readable recording medium” refers to a portable medium such as a flexible disk, a magneto-optical disk, a ROM, and a CD-ROM, and a storage device such as a hard disk built in a computer system. In this way, the recording medium in which the program is stored may be a non-transitory recording medium such as a CD-ROM.

Also, the recording medium also includes an internal or external recording medium that can be accessed from a distribution server to deliver the program. In addition, a configuration in which the program is divided into a plurality of pieces, each of which is downloaded at a different time and then combined with each component of the carbon dioxide recovery system 1 may be used, and the distribution servers delivering the divided pieces of the program may be different. Further, the “computer-readable recording medium” includes a medium that stores a program for a certain period of time such as a volatile memory (RAM) inside a computer system serving as a server or client in a case in which programs are transmitted via a network. Also, the above-described program may be a program for realizing some of the functions described above. Further, the program may be a so-called differential file (differential program) that can realize the above-described functions in combination with a program already recorded in the computer system.

### REFERENCE SIGNS LIST

1 Carbon dioxide recovery system
10 Carbon dioxide recovery apparatus
11 Container
12 Adsorbent
21 Elevator cab
21A Second elevator cab
22 Counterweight
25 Control panel
25A Second control panel
A1, A2 Ventilation opening
F Floor
P Hoistway
P1 Wall surface

What is claimed is:

1. A carbon dioxide recovery apparatus comprising:
a container having air permeability and disposed outside an elevator cab or outside a counterweight in a hoistway of the elevator cab; and
an adsorbent adsorbing carbon dioxide and contained in the container, wherein
when the elevator cab and the counterweight move up and down, air in the hoistway enters the inside of the container and air in the container is discharged into the hoistway.

2. The carbon dioxide recovery apparatus according to claim 1, wherein the container is fixed to at least one of an upper side and a lower side of the elevator cab.

3. The carbon dioxide recovery apparatus according to claim 1, wherein the container is fixed inside the hoistway.

4. A carbon dioxide recovery method comprising:
a filling step of filling an adsorbent adsorbing carbon dioxide into a container having air permeability and disposed outside an elevator cab or outside a counterweight in a hoistway of the elevator cab;
an adsorption step of causing carbon dioxide to be adsorbed onto the adsorbent by raising and lowering the elevator cab to bring the adsorbent into contact with air containing carbon dioxide; and
a recovery step of recovering the adsorbent which has adsorbed carbon dioxide from the container, wherein
in the adsorption step, air in the hoistway enters the inside of the container and air in the container is discharged into the hoistway.

5. The carbon dioxide recovery method according to claim 4, wherein the adsorbent is filled into the container so that a loading ratio of the elevator cab becomes 50% in the filling step.

6. The carbon dioxide recovery method according to claim 4, further comprising a concentration increasing step of increasing a carbon dioxide concentration in the hoistway by feeding air from a floor to the hoistway.

7. A carbon dioxide recovery system comprising:
the carbon dioxide recovery apparatus according to claim 1;
the elevator cab;
the counterweight; and
a control panel that controls raising and lowering of the elevator cab.

8. The carbon dioxide recovery system according to claim 7, wherein the control panel causes the adsorbent to be filled into the container when a loading ratio of the elevator cab is 50% or less.

9. The carbon dioxide recovery system according to claim 7, wherein the control panel raises and lowers the elevator cab when a stop time of the elevator cab exceeds a threshold value.

10. The carbon dioxide recovery system according to claim 7, further comprising:
a second elevator cab; and
a second control panel that controls raising and lowering of the second elevator cab, wherein
the second control panel communicates with the control panel and raises and lowers the second elevator cab if the elevator cab is stopped.

11. The carbon dioxide recovery system according to claim 7, wherein outside air is taken into the hoistway through a ventilation opening provided in the hoistway.
